(19) United States
(12) Patent Application Publication
(10) Pub. No.: US 2025/0203264 A1
(43) Pub. Date: Jun. 19, 2025

(54) External Magnetic Activation to Initiate Device Processing

(71) Applicant: Google LLC, Mountain View, CA (US)

(72) Inventors: Yao Ding, San Jose, CA (US); Chi Kin Benjamin Leung, Sunnyvale, CA (US)

(73) Assignee: Google LLC, Mountain View, CA (US)

(21) Appl. No.: 18/843,588

(22) PCT Filed: Jan. 26, 2023
(86) PCT No.: PCT/US2023/061378

§ 371 Date: Sep. 3, 2024

(51) Int. Cl. H04R 1/10; G06Q 10/0832; H02J 50/12

(52) U.S. Cl. CPC H04R 1/1025; G06Q 10/0832; H02J 50/12

(57) ABSTRACT

This document describes external magnetic activation to initiate device processing. In aspects, an electronic device detects a magnetic field having one or more field oscillations. Based on the detected magnetic field, the electronic device switches from a first, lower-power mode to a second mode that enables wireless communication. Upon receiving wireless communication signals, the electronic device initiates one or more operations. After completion of the one or more operations, the electronic device switches from the second mode to the first mode.

### BACKGROUND

Wireless hearable devices afford users many conveniences. For instance, they enable users to privately listen to audio without obtrusive cables. They also permit users to position a smart device that is wirelessly connected to a wireless hearable device anywhere on their body or even in a remote location. Users are also provided the opportunity to control their smart devices via their wireless hearable devices. Due to these conveniences, and many others, users greatly enjoy using wireless hearable devices.

These wireless hearable devices are designed in a variety of shapes and sizes. More than simply a design consideration for aesthetic purposes, the exterior design of a wireless hearable device often serves as a structural component to hold the wireless hearable device in place. For instance, some wireless hearable devices are configured to rest on top of, or over portions of, an ear (e.g., an auricle) using foam pads or polymer ear-hooks. Others are configured to fit within an ear (e.g., an external auditory canal) using polymer earbuds.

Despite the uniqueness in exterior designs and intended fits between wireless hearable devices, many wireless hearable devices share common features. As an example, most wireless hearable devices include a wireless communication component, speakers, a rechargeable battery, and so forth. In addition, many wireless hearable devices, such as wireless earbuds, are designed to be stored in a case.

### SUMMARY

Techniques and apparatuses are described directed at external magnetic activation to initiate device processing. In aspects, an electronic device detects a magnetic field having one or more field oscillations. Based on the detected magnetic field, the electronic device switches from a first, lower-power mode to a second mode that enables wireless communication. Upon receiving wireless communication signals, the electronic device initiates one or more operations. After completion of the one or more operations, the electronic device switches from the second mode to the first mode.

In aspects, a method is disclosed that includes: detecting, at an electronic device, a magnetic field; switching, at an electronic device and based on the detection of the magnetic field, from a first mode to a second mode, the first mode including an operating state of the electronic device in which the electronic device expends less electrical power than in an operating state of the electronic device in the second mode, the second mode including an operating state of the electronic device in which the electronic device is configured to receive wireless communication signals; initiating, at the electronic device and based on receiving wireless communication signals, one or more operations; and switching, at the electronic device, from the second mode to the first mode, the switching based on a completion of the one or more operations.

In aspects, an electronic device is disclosed that includes: a wireless communication component; a magnetic field sensing device; one or more processors; and memory coupled to the one or more processors, the memory storing one or more programs configured to be executed by the one or more processors, the one or more programs configured to detect a magnetic field, the magnetic field having one or more magnetic field oscillations; switch, at an electronic device and based on the detection of the magnetic field, from a first mode to a second mode, the first mode including an operating state of the electronic device in which the electronic device expends less electrical power than in an operating state of the electronic device in the second mode, the second mode including an operating state of the electronic device in which the electronic device is configured to receive wireless communication signals; initiate, at the electronic device and based on receiving wireless communication signals, one or more operations; and switch, at the electronic device, from the second mode to the first mode, the switching based on a completion of the one or more operations.

In aspects, a system is disclosed that includes: a magnetic field producing component; an electromagnetic wave detector; one or more processors; and memory coupled to the one or more processors, the memory storing one or more programs configured to be executed by the one or more processors, the one or more programs configured to produce a magnetic field, the magnetic field having one or more magnetic field oscillations; responsive to, or concurrent with, receiving an indication of a mode of an electronic device, transmitting wireless communication signals to a wireless communication component of the electronic device, the wireless communication signals directing the electronic device to perform one or more operations; and, responsive to determining a successful completion of the one or more operations from the electronic device, providing a notification.

This document also describes computer-readable media having instructions for performing the above-summarized methods and other methods set forth herein, as well as systems and means for performing these methods.

The details of one or more implementations are set forth in the accompanying Drawings and the following Detailed Description. Other features and advantages will be apparent from the Detailed Description, the Drawings, and the Claims. This Summary is provided to introduce subject matter that is further described in the Detailed Description. Accordingly, a reader should not consider the Summary to describe essential features nor limit the scope of the claimed subject matter.

### BRIEF DESCRIPTION OF DRAWINGS

Techniques and apparatuses directed at external magnetic activation to initiate device processing are described with reference to the following drawings. The same numbers are used throughout the drawings to reference like features and components:

FIG. 1-1 illustrates an example scenario of a buyer at a shopping mall who purchases and unboxes an electronic device;

FIG. 1-2 illustrates a conventional technique for updating software on the electronic device;

FIG. 1-3 illustrates an example scenario in which techniques enabling and apparatuses configured for external magnetic activation to initiate device processing may be embodied;

FIG. 2 illustrates an example smart device in accordance with one or more implementations;

FIG. 3 illustrates an example wireless hearable device in accordance with one or more implementations;

FIG. 4 illustrates an example portable electronic case in accordance with one or more implementations;

FIG. 5 illustrates a perspective view and a cross-sectional view of an example implementation of a portable electronic case;

FIG. 6 illustrates example actions initiated responsive to detecting a change to at least one characteristic of a detected magnetic field in accordance with one or more implementations;

FIG. 7 illustrates an example system configured to provide external magnetic activation in accordance with one or more implementations;

FIG. 8 illustrates an example driving signal transmitted to the magnetic field producing component effective to produce a magnetic field having one or more magnetic field oscillations with a particular characteristic in accordance with one or more implementations;

FIG. 9 illustrates an example method for implementing aspects of external magnetic activation to initiate device processing in accordance with one or more implementations; and

FIG. 10 illustrates an example method for implementing aspects of external magnetic activation to initiate device processing in accordance with one or more implementations.

### DETAILED DESCRIPTION

### Overview

Purchasers of electronic devices, such as smartphones, earbuds, and tablet computers, have grown accustomed to a positive unboxing experience. Electronic devices are usually boxed in sleek, aesthetically-pleasing packaging, which adds to the purchasers' enjoyment in purchasing the electronic devices. For this reason, vendors and manufacturers tend to avoid opening boxed electronic devices.

Unfortunately, electronic devices are often manufactured, boxed in appealing packaging, and shipped great distances with weeks of travel. Even further, after being received by vendors, such as local brick-and-mortar stores or online vendors, these electronic devices can remain in the possession of the vendor for weeks or even months before sale. During these long periods, changes to software and/or firmware, including how the software or firmware utilizes hardware (e.g., display brightness, battery discharge thresholds), on the electronic device are often needed. Because of this, some partial solutions have been devised to address the problem of software and/or firmware updates on electronic devices before, during, or after manufacturing and sale. A first partial solution includes keeping a wireless communication component (e.g., a radio, an antenna) activated at all times to be ready to receive wireless updates. In a second partial solution, electronic devices are unboxed and turned on during manufacturing or sale, so as to enable a download of an update. In a third partial solution, during manufacturing or sale, electronic devices are not updated with the most recent software or firmware updates despite one or more updates being available. Updates may not be installed for any of a variety of reasons, including the electronic device being powered off, a wireless communication component being deactivated, and so on. In such a solution, a purchaser may be required to initiate a download.

Each of these partial solutions, however, has limitations. For example, keeping a wireless communication component activated for extended periods of time during manufacturing and/or sale can deplete a battery charge level. If a battery fully depletes during this time, then an electronic device will no longer receive wireless updates. In addition, discovering a depleted battery during unboxing can devalue a purchaser's unboxing experience. As for the second partial solution, unboxing and booting electronic devices during manufacturing and/or sale can take time and be costly. Furthermore, it can detract from a purchaser's unboxing experience.

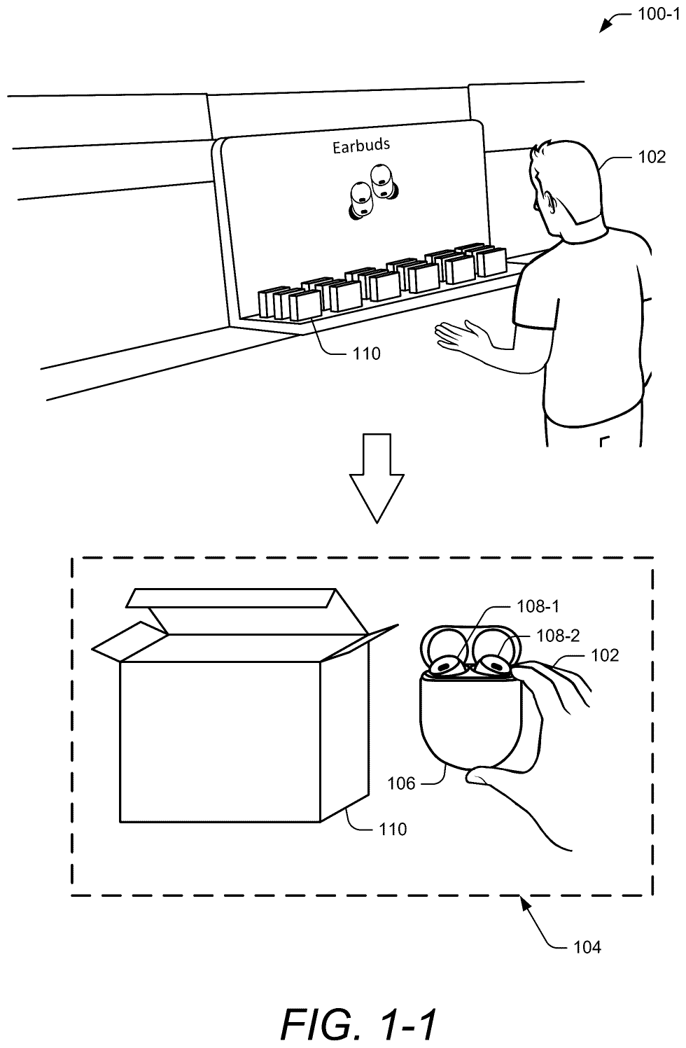

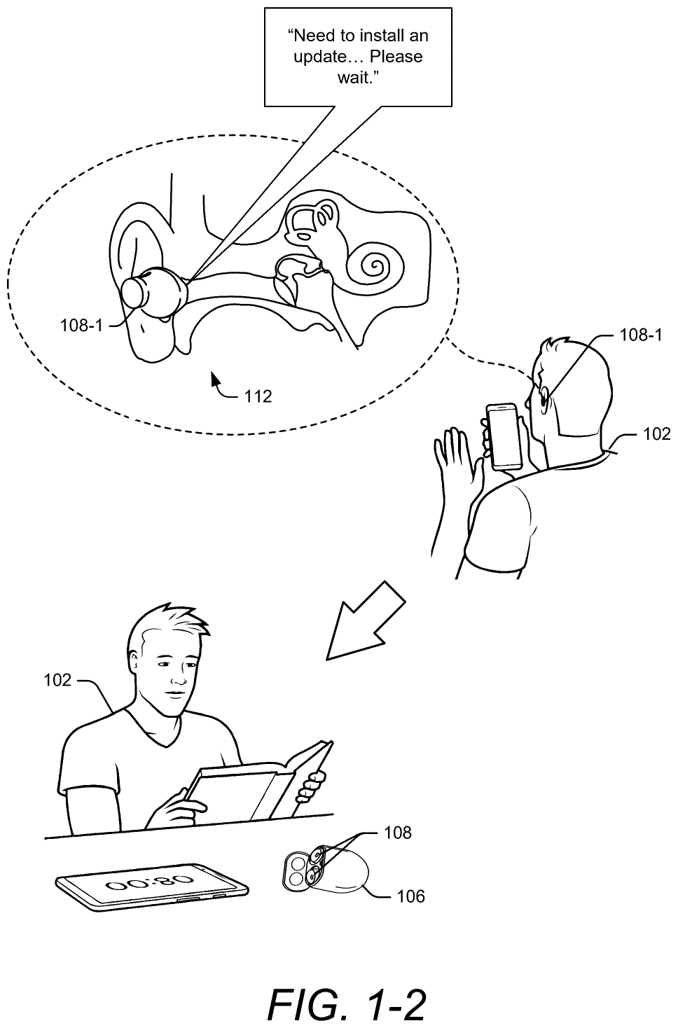

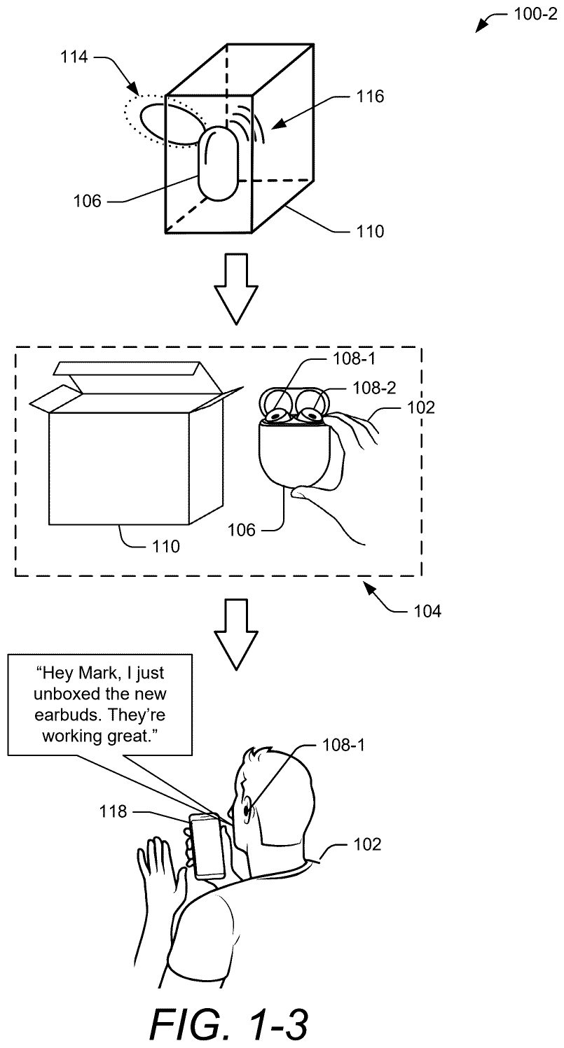

In regard to the third partial solution, consider FIG. 1-1, which illustrates an example scenario 100-1 of a purchaser 102 who purchases and unboxes 104 an electronic device. As illustrated, the electronic device is a portable electronic case 106 with wireless earbuds 108 (e.g., wireless earbud 108-1, wireless earbud 108-2) residing therein. Assume, as an example, that the portable electronic case 106 and wireless earbuds 108 were manufactured and sealed in a package 110 five weeks (for example) prior to the purchaser 102 purchasing the portable electronic case 106 and wireless earbuds 108. At some point during those five weeks, a software update to improve the function of the portable electronic case 106 and/or wireless earbuds 108 was released.

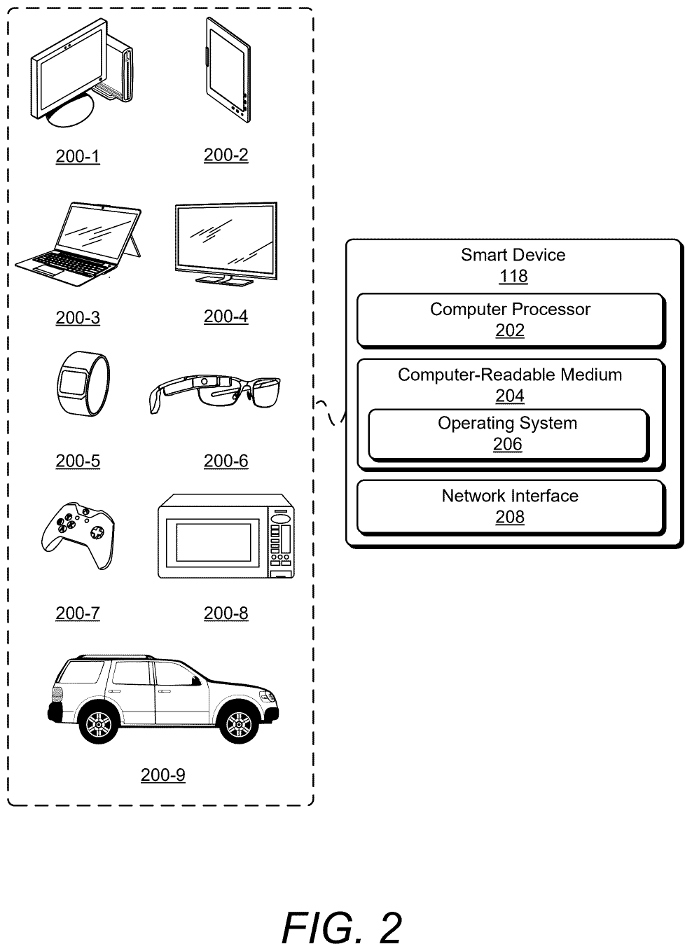

After unboxing 104 the portable electronic case 106, the purchaser 102 (also referred to as user 102) may open a lid of the portable electronic case 106 and remove the wireless earbuds 108 from the portable electronic case 106. Now consider FIG. 1-2, which depicts a conventional technique (e.g., the third partial solution) for updating software on the electronic device.

After fitting a wireless earbud 108-1 into an ear 112, the user 102 may subsequently receive a prompt to update the wireless earbuds 108. As a result, the user 102 may not get an opportunity to use the wireless earbuds 108 immediately after purchase. Further, the user 102 may have to wait for the update to download and install. Such a solution may trivialize the user's 102 unboxing experience.

In contrast, this document describes techniques and apparatuses directed at external magnetic activation to initiate device processing. Through such techniques, a packaged and sealed electronic device that is in a low power mode (e.g., with one or more processors and wireless communication components deactivated) can be magnetically activated to enable a downloading and installation of a software update. In this way, the electronic device need not be physically removed from the packaging, nor the seal opened, in order to power on and initiate a software update.

The following discussion describes operating environments and techniques that may be employed in the operating environments and example methods. Although systems and techniques directed at external magnetic activation to initiate device processing are described, it is to be understood that the subject of the appended Claims is not necessarily limited to the specific features or methods described. Rather, the specific features and methods are disclosed as example implementations and reference is made to the operating environment by way of example only.

### Example Environment

Consider FIG. 1-3, which illustrates an example scenario 100-2 in which techniques enabling and apparatuses configured for external magnetic activation to initiate device processing may be embodied. As illustrated, an electronic device 106 (e.g., a portable electronic case) can be magnetically activated 114 while sealed in a package 110. As non-limiting examples, the magnetic activation 114 can occur at any point during manufacturing, shipping, or storage, or even while being advertised on a store shelf. In this way, the electronic device 106, preceding the magnetic activation 114, can operate in a low power state to conserve power, and then, once magnetically activated 114, the electronic device 106 can initiate device processing (e.g., activate one or more processors, initiate processing of one or more programs, engage in wireless data transfer). In more detail, the low power state may include one or more deactivated processors, one or more processors operating with a reduced clock speed, a deactivated wireless communication component, one or more deactivated sensors, and so on. Upon being magnetically activated 114, the electronic device 106 may operate in an increased power state. The increased power state may include an activated wireless communication component transmitting and/or receiving wireless communications 116 and one or more processors downloading and/or installing data, such as a software update. In this way, the one or more processors of the electronic device 106 may be processing little-to-no data while operating in the low power state. In the increased power state, however, the one or more processors may increase or initiate the processing of data related to wireless communication and/or installation upon being magnetically activated 114.

In some implementations, after wirelessly receiving and processing data, the electronic device 106 can switch back to the low power state from the increased power state. In this way, the electronic device 106 can, for example, install software or firmware while still sealed in the package 110. Moreover, the electronic device 106 can limit power expenditure by switching between increased and decreased power states. In this way, one or more stages of a product life-cycle (e.g., concept and design, development, production, and launch) of an electronic device (e.g., electronic device 106) can be completed more expeditiously. For instance, the timing for the production and launch of an electronic device need not be limited by the full development of software on the electronic device since the software can be updated remotely during, for example, sale.

Through such a technique, when the user 102 unboxes 104 the electronic device 106, the user 102 can immediately use the electronic device 106 without, for example, waiting for a software update. As illustrated in FIG. 1-3, the user 102 unboxes 104 the electronic device 106 (“portable electronic case 106”) containing wireless hearable devices 108 (e.g., wireless hearable device 108-1, wireless hearable device 108-2) and immediately connects them to a smart device 118. The user 102 can then use the wireless hearable devices 108 to support functions of the smart device 118, including listening to audio, calling friends, etc. Such a solution improves the user's unboxing experience 104 because the wireless hearable devices 108 are more-readily usable and the packaging 110 remained sealed from the point of manufacture to the point of unboxing 104. Moreover, external magnetic activation 114 to initiate device processing minimizes time and fees associated with premature unboxing (e.g., to install updates).

In more detail, FIG. 2 illustrates an example smart device 118 in accordance with one or more implementations. The smart device 118 is illustrated with various non-limiting example devices, including a desktop computer 200-1, a tablet 200-2, a laptop 200-3, a television 200-4, a computing watch 200-5, computing glasses 200-6, a gaming system 200-7, a microwave 200-8, and a vehicle 200-9. Other devices may also be used, such as a home service device, a smart speaker, a smart thermostat, a baby monitor, a Wi-Fi® router, a drone, a trackpad, a drawing pad, a netbook, an e-reader, a home automation and control system, a wall display, and another home appliance. Note that the smart device 118 can be wearable, non-wearable but mobile, or relatively immobile (e.g., desktops and appliances).

The smart device 118 includes one or more computer processors 202 and at least one computer-readable medium 204, which includes memory media and storage media. Applications and/or an operating system 206 embodied as computer-readable instructions on the computer-readable medium 204 can be executed by the computer processor 202 to provide some of the functionalities described herein, including transmitting audio to the wireless hearable devices 108.

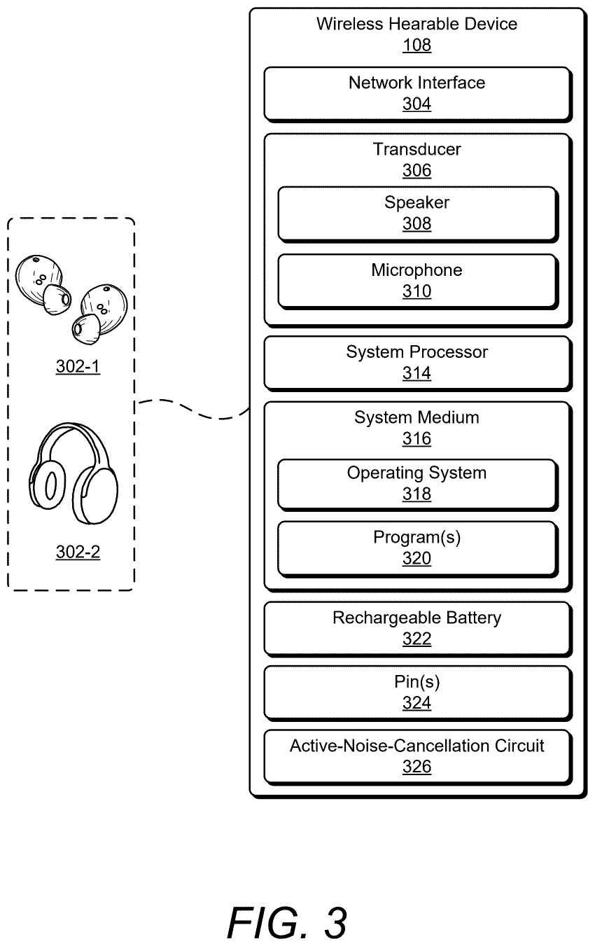

The smart device 118 can also include a network interface 208 for communicating data over wired, wireless, or optical networks. For example, the network interface 208 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, Bluetooth®, and the like. The smart device 118 may also include a display. Although not explicitly shown, the wireless hearable devices 108 can connect wirelessly to the smart device 118. The wireless hearable devices 108 are further described with respect to FIG. 3.

FIG. 3 illustrates an example wireless hearable device 108 in accordance with one or more implementations. The wireless hearable device 108 is illustrated with various non-limiting example devices, including wireless earbuds 302-1 and wireless headphones 302-2. The wireless earbuds 302-1 are a type of in-ear device that fits into an ear canal. Each wireless earbud 302-1 can represent a wireless hearable device 108. Headphones 302-2 can rest on top of or over the ears 108. Each headphone 302-2 includes two wireless hearable devices 108, which are physically packaged together. In general, there is one wireless hearable device 108 for each ear.

The wireless hearable device 108 includes a network interface 304 to communicate with the smart device 118 and, optionally, another wireless hearable device 108 (e.g., between wireless earbuds 302-1). In at least some implementations, the network interface 304 enables communication between the portable electronic case 106 and the wireless hearable device 108. For example, the network interface 304 may communicate data over a LAN, a WLAN, a PAN, a WAN, an intranet, the Internet, a peer-to-peer network, a point-to-point network, a mesh network, Bluetooth®, and the like. The network interface 304 is a wireless interface in which audio content is passed from the smart device 118 to the wireless hearable device 108. The wireless hearable device 108 can also use the network interface 304 to pass sensor data to the smart device 118.

The wireless hearable device 108 includes at least one transducer 306 that can convert electrical signals into sound waves. The transducer 306 can also detect and convert sound waves into electrical signals. These sound waves may include ultrasonic frequencies and/or audible frequencies. In particular, a frequency spectrum (e.g., range of frequencies) that the transducer 306 uses to generate an acoustic signal can include frequencies from a low-end of the audible range to a high-end of the ultrasonic range (e.g., between 20 hertz (Hz) and 2 megahertz (MHz)).

In an example implementation, the transducer 306 has a monostatic topology. With this topology, the transducer 306 can convert the electrical signals into sound waves and convert sound waves into electrical signals (e.g., can transmit or receive acoustic signals). Example monostatic transducers may include piezoelectric transducers, capacitive transducers, and micro-machined ultrasonic transducers (MUTs) that use microelectromechanical systems (MEMS) technology.

Alternatively, the transducer 306 can be implemented with a bistatic topology, which includes multiple transducers that are physically separate. In this case, a first transducer converts an electrical signal into sound waves (e.g., transmits acoustic signals), and a second transducer converts sound waves into an electrical signal (e.g., receives the acoustic signals). An example bistatic topology can be implemented using at least one speaker 308 and at least one microphone 310. The speaker 308 and the microphone 310 can be used for any of a variety of functions on behalf of the smart device 118 (e.g., presenting audible content to the user 102, capturing the user's voice for a phone call or voice control).

In general, the speaker 308 is directed towards the ear canal (e.g., oriented towards the ear canal) and the microphone 310 is directed in an outward direction (e.g., away from the ear). Accordingly, the speaker 308 can direct acoustic signals towards the ear canal, and the microphone 310 can receive sound waves from an ambient environment (e.g., speech from a user).

The wireless hearable device 108 also includes at least one system processor 314 and at least one system medium 316 (e.g., one or more computer-readable storage media). In the depicted configuration, the system medium 316 includes an operating system 318 and optionally includes one or more programs 320. In this example, the system processor 314 implements the operating system 318 and the one or more programs 320. In an alternative example, the computer processor 202 of the smart device 118 can implement at least a portion of the operating system 318 and/or the one or more programs 320.

The wireless hearable device 108 further includes a rechargeable battery 322 (e.g., a battery pack). The rechargeable battery 322 may be any suitable rechargeable battery. As described herein, the rechargeable battery 322 may be a Li-ion battery. Various different Li-ion-battery chemistries may be implemented, some examples of which include lithium cobalt oxide (LiCoO2), lithium iron phosphate (LiFePO4), lithium manganese oxide (LiMn2O4 spinel, or Li2MnO3-based lithium-rich layered materials, LMR-NMC), and lithium nickel manganese cobalt oxide (LiNiMnCoO2, Li-NMC, LNMC, NMC, or NCM and the various ranges of Co stoichiometry). Also, Li-ion batteries may include various different anode materials, including graphite-based anodes, silicon (Si), graphene, and other cation intercalation/insertion/alloying anode materials. The rechargeable battery 322 includes battery terminals for connection to a load and a charger.

In some implementations, the wireless hearable device 108 includes one or more pins 324 (e.g., an electrical contact) flush with an exterior housing of the wireless hearable device 108. In one example, the one or more pins 324 can be implemented as a general-purpose input/output (GPIO) pin and/or POGO pin. In some implementations, the battery terminals of the rechargeable battery 322 can be physically and electrically coupled to the one or more pins 324 (e.g., power supply pins). In doing so, the one or more pins 324 may extend from the rechargeable battery 322 to an exterior surface of a housing of the wireless hearable device 108. In this way, the one or more pins 324 can receive electrical power from an external power supply. The one or more pins 324 may also be used for data transfer.

In additional implementations, the wireless hearable device 108 can include a wireless charging circuit (e.g., an inductive charging circuit). The wireless charging circuit may be substituted for the one or more pins 324 or be included as a supplementary charging option. Further, the wireless charging circuit can enable other computing devices, in addition to the portable electronic case 106, to charge the wireless hearable device 108 (e.g., the smart device 118).

The wireless hearable device 108 may further include an active-noise-cancellation circuit 326, which enables the wireless hearable device 108 to reduce background or environmental noise. The wireless hearable device 108 may include additional components, such as an analog-to-digital converter circuit, light-emitting diodes (LEDs), etc., which are not illustrated. In some implementations, one or more components or features may be combined with other components and features of the wireless hearable device 108 and still implement the systems and techniques described herein. Still further, one or more components or features, including the one or more programs 320 and the active-noise-cancellation circuit 326, may be excluded from the wireless hearable device 108 and still implement the systems and techniques described herein.

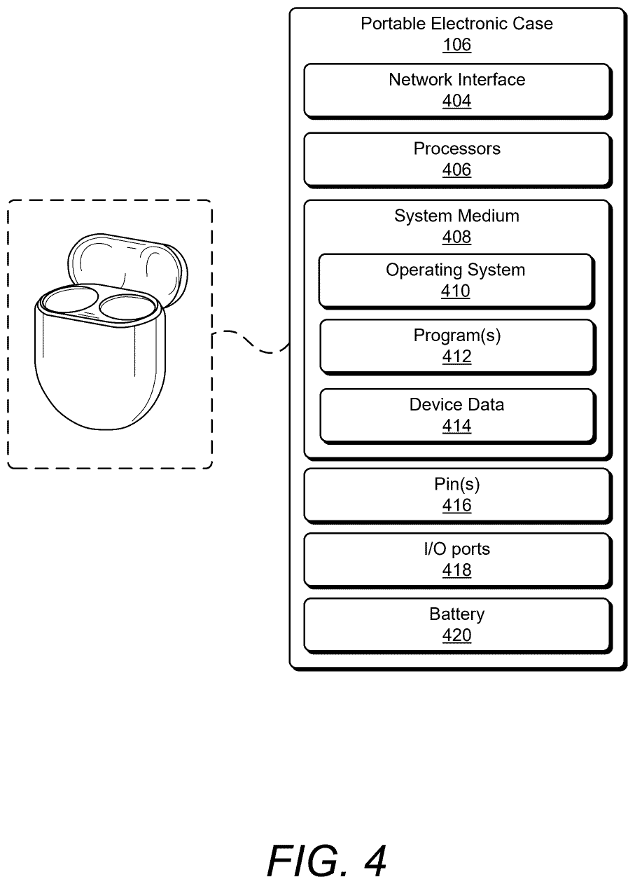

FIG. 4 illustrates an example portable electronic case 106 in accordance with one or more implementations. The portable electronic case 106 may provide housing (e.g., storage) for one or more wireless hearable devices 108 (e.g., wireless earbud 302-1, wireless earbud 302-2). In addition, the portable electronic case 106 may support functions of the one or more wireless hearable devices 108, including charging rechargeable batteries (e.g., rechargeable battery 322), enabling data transfer via pins 324, and so on.

The portable electronic case 106 includes a network interface 404 (e.g., a wireless interface) to wirelessly communicate with other computing devices. For example, the network interface 404 may communicate data over a LAN, a WLAN, a PAN, a WAN, an intranet, the Internet, a peer-to-peer network, a point-to-point network, a mesh network, Bluetooth®, and the like. In implementations, the network interface 404 can transmit and/or receive data, including sensor data and device data, to and/or from the portable electronic case 106, the one or more wireless hearable devices 108, the smart device 118, and/or other computing devices (e.g., a system providing software updates).

The portable electronic case 106 further includes one or more processors 406. The one or more processors 406 may include any suitable single-core or multi-core processor (e.g., an application processor (AP), a digital-signal processor (DSP), a central processing unit (CPU)). In at least some implementations, the one or more processors 406 may include a dedicated device such as an application-specific integrated circuit (ASIC), a microcontroller unit (MCU), a system-on-a-chip (SoC), or another hardware-based processor. The one or more processors 406 may be configured to execute instructions or commands stored within a system medium 408 and/or received from the smart device 118, the one or more wireless hearable devices 108, or another computing device. The system medium 408 can include an operating system 410, one or more programs 412, and device data 414. The device data 414 may include data relating to the portable electronic case 106, the smart device 118, and/or the one or more wireless hearable devices 108. In at least some implementations, the operating system 410 and/or one or more programs 412 implemented as computer-readable instructions on the system medium 408 can be executed by the one or more processors 406 to provide some or all of the functionalities described herein.

The system medium 408 may include one or more non-transitory storage devices such as a random access memory (RAM, dynamic RAM (DRAM), non-volatile RAM (NVRAM), or static RAM (SRAM)), read-only memory (ROM), or flash memory), hard drive, solid-state drive (SSD), or any type of media suitable for storing electronic instructions (e.g., programs), each coupled with a computer system bus. The instructions can be any set of instructions to be executed directly, such as machine code, or indirectly, such as scripts, by the one or more processors 406. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The portable electronic case 106 further includes one or more pins 416. When the one or more pins 324 of the wireless hearable device 108 are coupled to the one or more pins 416 of the portable electronic case 106, power and/or data lines may be established. As described herein, the term “coupled” may refer to two or more elements that are in direct contact (physically, electrically, magnetically, optically, etc.) or to two or more elements that are not in direct contact with each other but still cooperate and/or interact with each other.

Through such a technique, a power line and a ground line established via coupled pins (e.g., pins 324 and pins 416) between the portable electronic case 106 and one or more wireless hearable devices 108 can facilitate charging of the one or more wireless hearable devices 108. The coupled pins may also allow for full-duplex or half-duplex communication. The portable electronic case 106 and wireless hearable device 108 may each additionally include, for example, a multiplexer and/or demultiplexer to enable half-duplex or full-duplex communication over the one or more data lines and/or power lines. In this way, data and/or control signals may be transferred between the portable electronic case 106 and the one or more wireless hearable devices 108 over the power line and/or the data lines. The data may include any kind of information, such as battery levels, media playback information, software updates, firmware updates, etc. In some implementations, the data may be sent in packets.

The portable electronic case 106 may also include input/output (I/O) ports 418 separate from the one or more pins 416. The I/O ports 418 allow the portable electronic case 106 to interact with other devices or users, conveying any combination of digital signals, analog signals, and radiofrequency (RF) signals. The I/O ports 418 may include any combination of internal or external ports, such as universal serial bus (USB) ports (e.g., a USB-C port), audio ports, Serial ATA (SATA) ports, peripheral component interconnect express (PCI-express) based ports or card-slots, secure digital input/output (SDIO) slots, and/or other legacy ports. Various devices may be operatively coupled with the I/O ports 418, such as human-input devices (HIDs), external computer-readable storage media, or other peripherals.

In some implementations, a battery 420 of the portable electronic case 106 may be recharged via a wired connection through an I/O port 418. In additional or alternative implementations, a battery 420 of the portable electronic case 106 may be replaceable. In this way, an electrically-depleted battery 420 may be exchanged with another compatible battery.

Although techniques and apparatuses are described herein utilizing a portable electronic case 106, it should be understood to those skilled in the art that any suitable electronic device (e.g., a laptop, a tablet, a smartphone) can be substituted for the portable electronic case 106 and still perform one or more operations described herein.

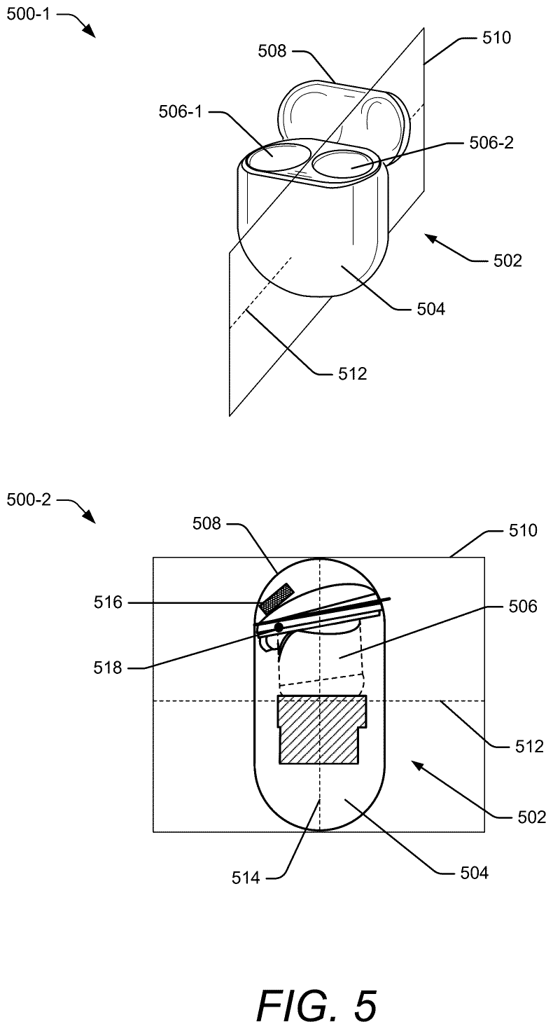

FIG. 5 illustrates a perspective view 500-1 and a cross-sectional view 500-2 of an example implementation of a portable electronic case 106. As illustrated, a housing 502 of the portable electronic case 106 may be designed to form an ovoid. In alternative implementations, the housing 502 of the portable electronic case 106 may be designed to form any of a variety of three-dimensional shapes, including a cuboid, a prism, and so on. Further illustrated, the housing 502 includes a body 504 defining at least one internal cavity 506 (e.g., first internal cavity 506-1, second internal cavity 506-2) for physically receiving one or more wireless hearable devices 108. In some implementations, the portable electronic case 106 includes a lid 508 for enclosing the one or more wireless hearable devices 108 within the housing 502. For example, perspective view 500-1 illustrates the portable electronic case 106 with the lid 508 open, while cross-sectional view 500-2 illustrates the portable electronic case 106 divided by a bisecting plane 510 with the lid 508 closed. The lid 508 may rotate about a hinge (not illustrated) that is connected to the body 504 and the lid 508. The hinge may be located on a rear face of the portable electronic case 106. When the lid 508 rotates about the hinge into an open position, the at least one internal cavity 506 may be visible from at least an angle ranging (e.g., clockwise) from a center axis 512 (e.g., an axis normal to a front face) to a vertical axis 514.

Although an example portable electronic case 106 has been described and illustrated with a rotating lid 508, the portable electronic case 106 may be configured differently and still implement the systems and techniques described herein. For example, another portable electronic case may include a lid that slides, or otherwise travels, from one side of the portable electronic case to another side of the portable electronic case in a plane that is normal to the bisecting plane 510. In another example, a portable electronic case may include a detachable lid.

The portable electronic case 106 further includes a magnet 516 in the lid 508 (“lid magnet 516”). The lid magnet 516 may be implemented as any physical object or circuit component that produces a magnetic field, including a permanent magnet, an inductor, or an electromagnet. The lid magnet 516 may produce a magnetic field, including a static magnetic field (e.g., not changing intensity and/or direction over time) and/or a non-static magnetic field.

A magnetic field sensing device 518 can be positioned in the body 504 of the portable electronic case 106 and can be used to detect the magnetic field from the lid magnet 516. The magnetic field sensing device 518 can transmit sensor data indicative of at least a magnitude or direction of the magnetic field (e.g., relative to the position of the magnetic field sensing device 518). In implementations, the magnetic field sensing device 518 detects the magnetic field of the lid magnet 516 only when the lid 508 is in a closed configuration. In alternative implementations, the magnetic field sensing device 518 detects the magnetic field of the lid magnet 516 in a closed, near-closed, and/or open configuration. In these alternative implementations, if the magnitude of the magnetic field exceeds a threshold, then the one or more processors 406 communicatively coupled to the magnetic field sensing device 518 can determine if the lid 508 is in the closed configuration. For example, the determination may be based on a magnitude of the magnetic field indicative of a proximity (e.g., vicinity) of the lid magnet 516 to the magnetic field sensing device 518.

The magnetic field sensing device 518 may be implemented as a magnetometer, a Hall Effect Sensor (HES sensor), a microelectromechanical (MEMS) magnetic field sensor, and/or any other type of magnetic field sensing sensor. In some implementations, the magnetic field sensing device 518 is implemented as a HES sensor due to its low power consumption, high durability, noise immunity, and reliability. The HES sensor may be a unipolar HES sensor with dual outputs, capable of identifying north or south poles. The HES sensor may also possess an output rate of 20 hertz. In further implementations, the magnetic field sensing device 518 is configured to boot (e.g., awaken, activate) the one or more processors 406. The magnetic field sensing device 518 can be disposed in the body 504 of the portable electronic case 106 such that when the lid 508 is in a closed configuration, the magnetic field sensing device 518 is positioned adjacent, near, and/or underneath the lid magnet 516.

The magnetic field sensing device 518 may be configured with any of a variety of magnetic field detecting sensitivities, including microteslas, decateslas, and so on. The magnetic field sensing device 518 can, in some implementations, alter an operating state (e.g., adjust a processor clock speed, increase a number of operations per second (OPS), increase a number of activated components) of the portable electronic case 106 based on a change in a magnitude of a detected magnetic field. For example, based on detecting a decrease in a magnitude of a magnetic field at the magnetic field sensing device 518, the one or more processors 406 of the portable electronic case 106 may elevate the operating state from a deactivated state to an activated state. In another example, based on detecting a decrease in a magnitude of a magnetic field at the magnetic field sensing device 518, the one or more processors 406 may switch an operating mode of the portable electronic case 106, causing an activation of deactivated components (e.g., the network interface 404), an increase in internal clock speeds, and/or an execution of one or more programs 412. Additionally, the one or more processors 406 may activate deactivated components of the one or more wireless hearable devices 108 (e.g., network interface 304, system processor 314, transducer 306) and/or cause the execution of one or more programs 320 via the system processor 314.

In aspects, a change in a magnitude of a detected magnetic field, including the detection of no magnetic field or a reverse magnetic field by the magnetic field sensing device 518, may be determined by the one or more processors 406 as an indication of the lid 508 being in an open configuration and/or changing from a closed configuration to the open configuration. Additionally, changes to at least one characteristic (e.g., a magnitude, a direction, a frequency, a phase shift) of a detected magnetic field by the magnetic field sensing device 518, while the one or more wireless hearable devices 108 are residing in the portable electronic case 106, may cause the one or more processors 406 of the portable electronic case 106 to perform any number of actions.

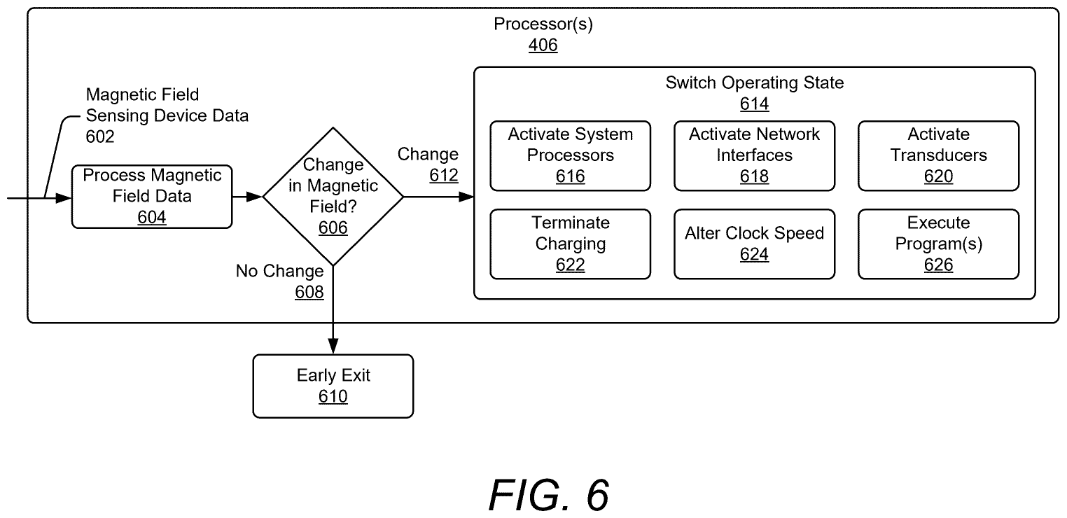

FIG. 6 illustrates example actions initiated responsive to detecting a change to at least one characteristic of a detected magnetic field in accordance with one or more implementations. As illustrated, in a first operation, the one or more processors 406 of the portable electronic case 106 receive data (“magnetic field data 602”) from the magnetic field sensing device 518. In some implementations, the magnetic field data 602 may be received actively or passively. For instance, a passive receipt of the magnetic field data 602 can involve the magnetic field sensing device 518 (e.g., based on the type of magnetic field data received) transmitting a signal that closes a switch in internal circuitry of the portable electronic case 106 and, subsequently, causes the battery 420 to supply electrical power to the one or more processors 406. The one or more processors 406 may then receive the magnetic field data 602. In another example, the one or more processors 406 may be electrically powered and actively receive the magnetic field data 602. In either case, responsive to receiving the magnetic field data 602, the one or more processors 406 may process 604 the magnetic field data 602. The processing 604 may include filtering the data and performing signal analysis.

In a next operation, the one or more processors 406 may determine 606 if the magnetic field data 602 indicates a change in at least one characteristic of the detected magnetic field (e.g., based on characteristics of previously logged magnetic field sensing device data, at least one characteristic exceeding or falling below a threshold). As an example, the change in at least one characteristic can include, for example, a decrease in a magnitude (e.g., an intensity) of the detected magnetic field. As illustrated, if the one or more processors 406 determine 606 no change 608 in at least one characteristic of the detected magnetic field, then the one or more processors 406 may exit early 610 (e.g., cease further actions). Otherwise, if the one or more processors 406 determine 606 a change 612 in at least one characteristic of the detected magnetic field, then the one or more processors 406 can switch (e.g., elevate) an operating state 614. In the switched operating state 614, the one or more processors 406 can perform any number of operations based on a number and/or a type of the change 612 in the at least one characteristic of the detected magnetic field.

Example operations performed in response to switching the operating state 614 include: at operation 616, activating system processors 314 of the one or more wireless hearable devices 108; at operation 618, activating network interfaces 304 of the one or more wireless hearable devices 108 and/or network interfaces 404 of the portable electronic case 106; at operation 620, activating transducers 306 of the one or more wireless hearable devices 108; at operation 622, terminating a charging of the one or more wireless hearable devices 108; at operation 624, altering a clock speed of processors (e.g., system processor 314, processors 406) of the one or more wireless hearable devices 108 and/or of the portable electronic case 106; and/or at operation 626, executing one or more programs (e.g., program(s) 320, program(s) 412) on or of the one or more wireless hearable devices 108 and/or on or of the portable electronic case 106. At least some of these operations may be initiated by the one or more processors 406 of the portable electronic case 106 via coupled pins and/or network interfaces.

In one example, one or more processors 406 of a portable electronic case 106 can be in a deactivated state (e.g., powered off, powered on but not processing data). Upon detecting a change to at least one characteristic of a detected magnetic field (e.g., a decrease in magnitude) via a magnetic field sensing device 518, the magnetic field sensing device 518 can transmit a signal effective to activate the one or more processors 406. The one or more processors 406 of the portable electronic case 106 may then receive and process the magnetic field data. Based on a determined change in the detected magnetic field, the one or more processors 406 can activate, via coupled pins, system processors 314, network interfaces 304, and transducers 306 of one or more wireless hearable devices 108 residing in the portable electronic case 106.

In another example, a network interface 404 of a portable electronic case 106 can be deactivated and one or more processors 406 of the portable electronic case 106 can be operating with a reduced clock speed. Upon detecting changes to at least one characteristic of a detected magnetic field (e.g., magnetic field oscillations radiating at a particular frequency) via a magnetic field sensing device 518, the one or more processors 406 can alter (e.g., increase) a clock speed, activate a network interface 404, and/or execute one or more programs 412. The one or more processors 406 of the portable electronic case 106 may then process the magnetic field data. Based on a determined change in the detected magnetic field, the one or more processors 406 can activate, via coupled pins, system processors 314 and network interfaces 304 of one or more wireless hearable devices 108 residing in the portable electronic case 106.

Activation of network interfaces (e.g., network interface 304, network interface 404) of one or more wireless hearable devices 108 and of the portable electronic case 106 may involve broadcasting wireless signals (e.g., for pairing). For example, activation of the one or more wireless hearable devices 108 and their respective network interface 304 may involve each of the network interfaces 304 transmitting and receiving signals between each other.

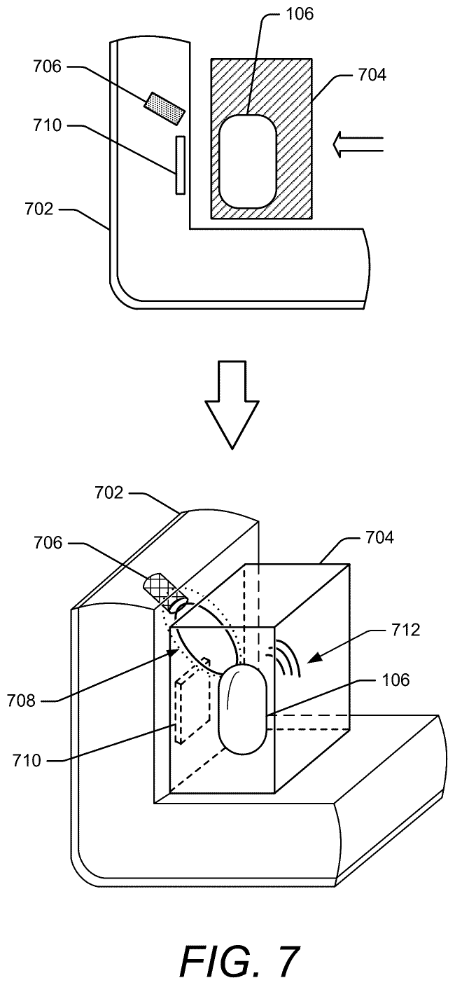

FIG. 7 illustrates an example system 702 configured to provide external magnetic activation in accordance with one or more implementations. As illustrated, the example system 702 is depicted with a platform (e.g., an L-shaped platform) onto which a sealed package 704 (e.g., package 110) with a portable electronic case 106 (or any electronic device) may be placed. Although illustrated with an L-shaped platform, the platform of system 702 may be designed to form any of a variety of shapes and/or include additional components. In one example, the system 702 may be designed as a conveyor belt assembly. In another example, the L-shaped platform may include limiting blocks configured to facilitate a horizontal positioning of the sealed package 704 on the L-shaped platform. In addition, the example system 702 may include low-pressure-activated switches (not illustrated), such as a snap-action switch.

In aspects, the sealed package 704 may be positioned on or adjacent to a magnetic field producing component 706 associated with (e.g., integrated within) the system 702, such that a magnetic field sensing device (e.g., magnetic field sensing device 518) of the portable electronic case 106 is within a vicinity of a magnetic field 708 emitted by the magnetic field producing component 706. The magnetic field producing component 706 can be implemented as one or more of a permanent magnet, an inductor (e.g., a solenoid), or any other magnetic field producing hardware component.

In implementations, the system 702 can be configured with sensors (not illustrated) to determine a positioning of the sealed package 704. The sensors can include a proximity sensor, a radar-based sensor, an image sensor, a scale, an infrared sensor, and so on. Based on a determined positioning of the sealed package 704, the system 702 can provide a magnetic field 708 sufficient to be detected by the magnetic field sensing device of the portable electronic case 106. In implementations, an intensity and/or a direction of the magnetic field 708 is alterable based on the determined positioning of the sealed package 704. In addition, a location of the magnetic field producing component 706 associated with the system 702 may be automatically altered based on the determined positioning of the sealed package 704 and/or a location of the portable electronic case 106 within the sealed package 704. For example, a sensor of the system 702, such as an image sensor, can determine an orientation of the sealed package 704 and/or a type of electronic device within the sealed package 704. Processors (not illustrated) of the system 702 can then determine a location of the magnetic field producing component 706 to provide a magnetic field 708 sufficient for detection by the magnetic field sensing device of the portable electronic case 106.

The magnetic field producing component 706 can be configured to produce a magnetic field 708 with magnetic field oscillations. In implementations, the magnetic field oscillations can possess a number of characteristics, including any of a variety of frequencies, magnitudes, and directions. Data may be encoded in the magnetic field oscillations (e.g., in the one or more characteristics). For instance, a frequency of the magnetic field oscillations (e.g., pulses) may indicate (e.g., represent) information detectable and usable by one or more processors 406 of the portable electronic case 106.

Further, these magnetic field oscillations having one or more characteristics can be produced by the magnetic field producing component 706 for a predetermined duration. For example, the magnetic field producing component 706 can produce an alternating magnetic field with precise timing. The magnetic field sensing device of the portable electronic case 106 can detect the alternating magnetic field 708 and transmit sensor data (e.g., magnetic field data 602) to the one or more processors 406, and the processors 406 of the portable electronic case 106 can process the sensor data to determine one or more characteristics of the magnetic field oscillations and decode information indicated by (e.g., contained in) the magnetic field oscillations. In implementations, the processors 406 can determine if a pulse train of the detected magnetic field 708 meets certain criteria (e.g., if the detected magnetic field 708 is authentic). Based on at least one of a change in the characteristics of the oscillations and, optionally, an identification of an authentic magnetic field 708, the processors 406 may activate the portable electronic case 106 and the one or more wireless hearable devices 108.

Activation of the portable electronic case 106 and the one or more wireless hearable devices 108, including their respective network interfaces (e.g., network interface 404, network interface 304), may involve their network interfaces broadcasting wireless signals (e.g., for pairing). For example, activation of the one or more wireless hearable devices 108 and their respective network interfaces 304 may involve each of the network interfaces 304 transmitting and receiving signals between each other. An electromagnetic wave detector 710 (e.g., a detection coil and an amplifier) associated with (e.g., integrated within) the system 702 may be configured to detect electromagnetic waves emitted from the one or more wireless hearable devices 108 and/or the portable electronic case 106 to determine if the external magnetic activation initiated device processing (e.g., broadcasting wireless signals).

Upon the external magnetic activation and the subsequently initiated device processing, the one or more wireless hearable devices 108 and/or the portable electronic case 106 can receive and/or transmit wireless communication signals 712, including software updates, firmware updates, etc. In some implementations, the wireless communication signals 712 can originate from the system 702 or from another computing device (e.g., a router).

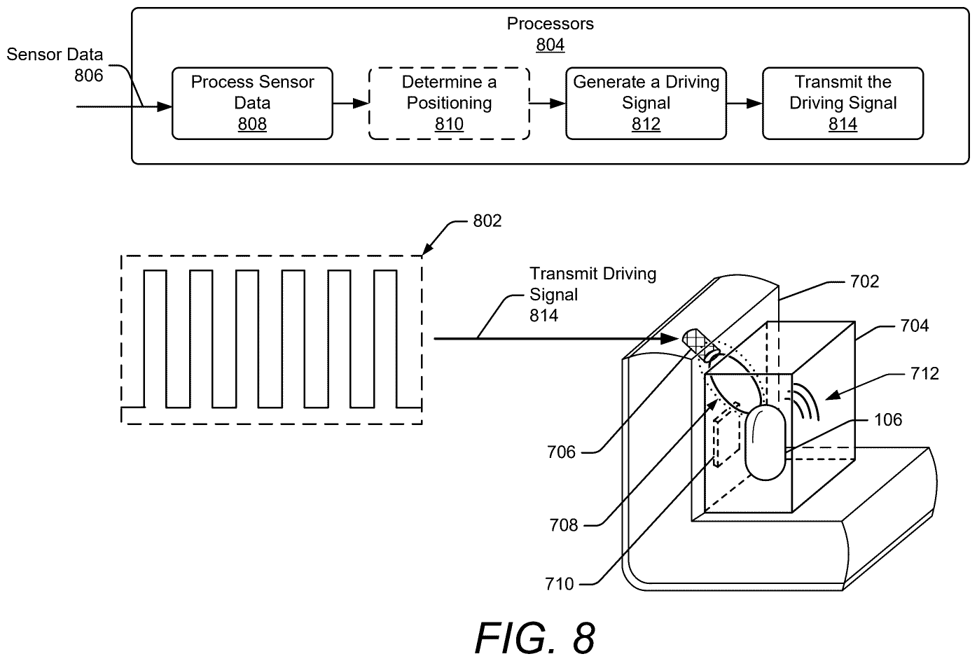

FIG. 8 illustrates an example driving signal 802 transmitted to the magnetic field producing component 706 effective to produce a magnetic field 708 having one or more magnetic field oscillations with a particular characteristic in accordance with some implementations. As illustrated, processors 804 of the system 702 receive sensor data 806 and then process 808 the sensor data. The sensor data 806 may indicate that a sealed package 704 is positioned on or proximate to the system 702. In one example, the sensor data 806 can be obtained from a proximity sensor or a scale. In another example, the sensor data 806 can be obtained from a push button or a touch-sensitive display by which a user of the system 702 may intend to initiate external magnetic activation. In additional implementations, the sensor data 806 can include data relating to a positioning of the sealed package 704 with respect to the magnetic field producing component 706. Optionally, based on data relating to the positioning of the sealed package 704, the processors 804 can determine a positioning 810 of the sealed package 704 and perform one or more operations (not illustrated) responsive to the determination 810, such as providing an audible (e.g., via a speaker) or visual (e.g., via a display, via an LED) notification to a user of the system 702, altering a position of the magnetic field producing component 706, altering a positioning of the sealed package 704, generating a variable driving signal effective to produce a magnetic field 708 with a variable intensity and direction based on a proximity of the sealed package 704 and/or portable electronic case 106 in the sealed package 704, or any combination thereof.

In a next step, the processors 804 can generate a driving signal 812. For example, the driving signal 802 can include a peak-to-peak 200 millivoltage, 5 hertz square wave. The processors 804 can then transmit the driving signal 814 to the magnetic field producing component 706, which, upon receipt of the driving signal 802, can generate a magnetic field 708 with one or more oscillations. For instance, the magnetic field producing component 706, driven by the driving signal 802, can generate a magnetic field 708 that, when detected by the magnetic field sensing device of the portable electronic case 106, reproduces a 50% duty square wave at 5 hertz. In some implementations, the magnetic field sensing device of the portable electronic case 106 can sample the detected magnetic field 708 at eight or sixteen times during a 200-millisecond interval.

Through such techniques and apparatuses, the system 702 can generate a magnetic field 708 (“external magnetic field 708”) detectable by a magnetic field sensing device of a portable electronic case 106. The external magnetic field 708 can be external to the portable electronic case 106 and may influence (e.g., steer, overpower) a magnetic field (e.g., a magnetic field of a lid magnet 516) near the magnetic field sensing device. The external magnetic field 708 can, in some implementations, mimic a magnetic field that would be detected (or not detected) by the magnetic field sensing device resultant to the lid 508 being in an open configuration. In addition, or alternatively, the external magnetic field 708 can cause one or more processors 406 of the portable electronic case 106 to switch an operating state (e.g., switch operating state 614) based on one or more characteristics of the magnetic field oscillations.

In further implementations, the system 702 can wirelessly charge the portable electronic case 106 while sealed in the package 704. In some implementations, the magnetic field producing component 706 can inductively charge the portable electronic case 106.

The external magnetic field 708, which causes the portable electronic case 106 to switch an operating state, may initiate device processing on the portable electronic case 106 and the one or more wireless hearable devices 108. Device processing can include activating network interfaces (e.g., network interface 304, network interface 404) and broadcasting wireless signals. The electromagnetic wave detector 710 (e.g., a detection coil and an amplifier) associated with (e.g., integrated within) the system 702 may be configured to detect electromagnetic waves emitted from the one or more wireless hearable devices 108 and/or the portable electronic case 106 to determine if the external magnetic activation initiated device processing (e.g., broadcasting wireless signals).

Upon initiation of device processing based on external magnetic activation, the one or more wireless hearable devices 108 and/or the portable electronic case 106 can receive wireless communication signals 712, including software updates, firmware updates, etc. In some implementations, the wireless communication signals 712 can originate from the system 702 or from another computing device (e.g., a router).

In an example, a portable electronic case (e.g., portable electronic case 106) housing two wireless hearable devices (e.g., wireless hearable devices 108) is sealed in a package (e.g., sealed package 704) for shipping and, optionally, advertisement. The portable electronic case is manufactured having a battery (e.g., battery 420) larger than each battery (e.g., rechargeable battery 322) of the two wireless hearable devices. In some operating states, the battery of the portable electronic case is configured to charge each battery of the two wireless hearable devices. While in a shipping mode, however, the portable electronic case (e.g., processors 406) disables charging of the batteries of the two wireless hearable devices. The shipping mode may be a mode configured to operate the portable electronic case in a manner that is compliant with one or more international shipping standards (e.g., Federal Aviation Administration (FAA) regulations). In one example, the shipping mode may operate the portable electronic case, and by extension the wireless hearable devices, in a way that complies with regulations or standards as specified by the Federal Communications Commission (FCC) in the Code of Federal Regulations (CFR) Title 47 Part 15. In the shipping mode, the portable electronic case may disable (e.g., power down wireless communication components, cease wireless communications) a network interface (e.g., network interface 304, network interface 404) and/or disable a charging of rechargeable batteries.

The portable electronic case may further include an internal, magnetically-activated circuit having a magnetic field sensing device (e.g., magnetic field sensing device 518), as well as one or more internal magnetic-field producing components (e.g., lid magnet 516). In operation, the internal, magnetically-activated circuit, via the magnetic field sensing device, can detect when a lid (e.g., lid 508) is in an open configuration or a closed configuration based on a detection of an intrinsic magnetic field (e.g., a magnitude) from the one or more internal magnetic-field producing components. As described herein, the term intrinsic magnetic field describes a magnetic field whose source is a component that is internal to or inherent with a given device or object.

When the portable electronic case is operating in a shipping mode (e.g., with or without a processor being activated), the internal, magnetically-activated circuit can, depending on an implementation, awaken the processor and/or provide magnetic field data to the processor. If the magnetic field data is indicative of the lid being in the open configuration, then the processor may switch an operating state from the shipping mode to a normal mode (e.g., an operating state in which the portable electronic case fully powers all components, permits wireless communication, and enables the charging of rechargeable batteries). If the magnetic field data is indicative of an external magnetic field that originates from a source external to the portable electronic case (e.g., based on a magnitude, a frequency, an encoded signal), then the processor may switch an operating state from the shipping mode to a zombie mode (e.g., an operating state in which the portable electronic case temporarily enables wireless communication and/or enables the charging of rechargeable batteries). In the zombie mode, the portable electronic case may perform one or more operations, including receive and store wireless software updates. While in the zombie mode, the portable electronic case may still operate in a low power mode. Upon completion of the one or more operations, the portable electronic case can switch (e.g., return back to) an operating state from the zombie mode to the shipping mode.

### Example Methods

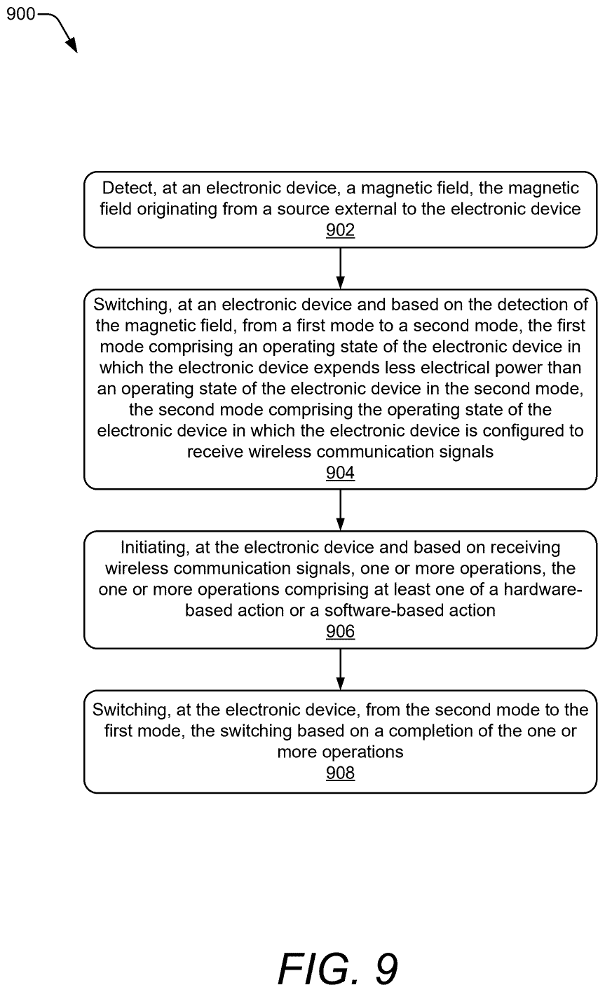

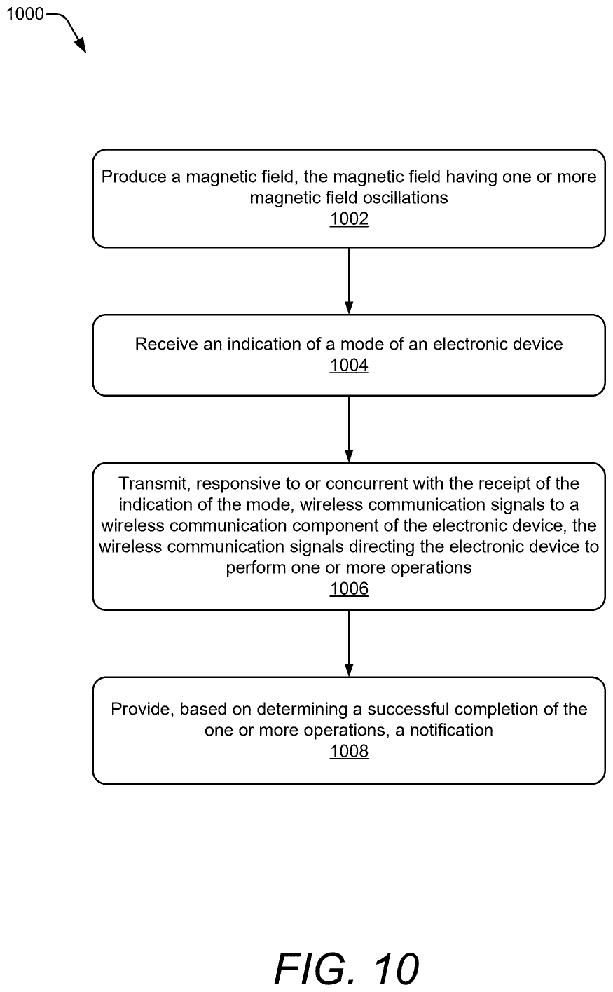

FIGS. 9 and 10 depict example methods 900 and 1000 for implementing aspects of external magnetic activation to initiate device processing in accordance with one or more implementations. Methods 900 and 1000 are shown as sets of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100-2 of FIGS. 1-3, and entities detailed in FIGS. 2-8, reference to which is made for example only. The techniques are not limited to performance by one entity or multiple entities operating on one device.

At 902 in FIG. 9, a magnetic field produced by a source external to the electronic device is detected. The magnetic field can be detected via a magnetic field sensing device associated with (e.g., integrated within) an electronic device, such as a portable electronic case. In some implementations, the electronic device may be contained in a sealed package. Further, the magnetic field may include one or more magnetic field oscillations. For example, the field oscillations can include one or more pole switches. The magnetic field oscillations can include one or more characteristics, including varying magnitudes, a variable frequency, and a direction. The magnetic field including one or more field oscillations having a particular characteristic can be produced by a system for a predetermined duration such that the electronic device can detect the magnetic field and, optionally, determine an authenticity of the detected magnetic field.

At 904, an electronic device switches from a first mode to a second mode based on the detected magnetic field. In some implementations, the switching is further based on the authenticity of the detected magnetic field. The switching from the first mode to the second mode may include booting up the electronic device. In addition, or alternatively, switching from the first mode to the second mode may include elevating a first operating state to a second operating state, where the first operating state is a lower power state than the second operating state. In either case, switching from the first mode to the second mode enables wireless communication.

At 906, while in the second mode, the electronic device initiates one or more operations (e.g., device processing). The one or more operations include: activating system processors 314 of the one or more wireless hearable devices 108; activating network interfaces 304 of the one or more wireless hearable devices 108 and/or network interfaces 404 of the portable electronic case 106; activating transducers 306 of the one or more wireless hearable devices 108; terminating a charging of the one or more wireless hearable devices 108; altering a clock speed of processors (e.g., system processor 314, processors 406) of the one or more wireless hearable devices 108 and/or of the portable electronic case 106; and/or executing one or more programs (e.g., program(s) 320, program(s) 412) on or off the one or more wireless hearable devices 108 and/or on or of the portable electronic case 106. At least some of these operations may be initiated by the one or more processors 406 of the portable electronic case 106 via coupled pins and/or network interfaces. In some implementations, the one or more operations further include, responsive to activation of network interfaces, data transfer, including downloading and installing a software or firmware update. One or more operations may involve a hardware-based action such as causing an illumination of an LED, opening a lid, physically adjusting circuit components, etc. The one or more operations can further include broadcasting wireless signals via network interfaces (e.g., pairing). The one or more operations may be sensed by the system and cause the termination of the external magnetic field.

At 908, the electronic device switches from the second mode to the first mode based on a completion of the one or more operations. The completion of the one or more operations may include a successful download and/or installation of data. In some implementations, the electronic device may switch from the second mode to the first mode before, concurrent with, after, or responsive to the magnetic field sensing device 518 no longer detecting an external magnetic field.

At 1002 in FIG. 10, an external magnetic field is produced. The magnetic field may include one or more magnetic field oscillations radiating at a particular frequency and magnitude. As described herein, the magnetic field may be referred to as external because the magnetic field is produced by a component external to an electronic device. Further, the magnetic field can be referred to as remote (“remote magnetic field”) because the magnetic field is produced by a component that is remote (e.g., positionally) in relation to the electronic device. Hence, the electronic device may experience remote magnetic activation by an external (e.g., remote) magnetic field producing component. The component may be implemented as an inductor, such as a solenoid, or a permanent magnet. For instance, a permanent magnet positioned in proximity to (e.g., within a vicinity of) a magnetic field sensing device may alter (e.g., overcome) a magnetic field generated by a magnet in a lid of a portable electronic case, switching a detected pole (e.g., one magnetic field oscillation).

At 1004, an indication of a mode of an electronic device is received. The mode of the electronic device may be obtained, for example, by an electromagnetic wave detector. The electromagnetic wave detector may be configured to detect wireless signals broadcasted by electronic devices which were activated in response to the produced magnetic field. In one example, receipt of the wireless broadcast signals may indicate that one or more electronic devices switched from a first mode in which broadcast signals were previously not transmitted to a second mode in which broadcast signals are transmitted.

At 1006, wireless communication signals are transmitted to a wireless communication component of the electronic device. The wireless communication signals may be transmitted in response to or concurrent with receipt of the indication of the mode. The wireless communication signals can include instructions directing the electronic device to perform one or more operations, including an installation of software or firmware updates.

At 1008, a notification is provided. The notification may be provided based on determining a successful completion of the one or more operations. For example, the determination can be based on a cessation in receiving electromagnetic waves by the electromagnetic wave detector and/or receiving a wireless communication signal indicative of a successful completion. In additional or alternative implementations, the notification may be provided responsive to transmitting the wireless communications signals to the wireless communication component of the electronic device and before the completion of the one or more operations. The notification can include any combination of visual or audible notifications.

### Additional Examples

In the following section, additional examples are provided.

Example 1: A method comprising: detecting, at an electronic device, a magnetic field, the magnetic field originating from a source external to the electronic device; switching, at an electronic device and based on the detection of the magnetic field, from a first mode to a second mode, the first mode comprising an operating state of the electronic device in which the electronic device expends less electrical power than in an operating state of the electronic device in the second mode, the second mode comprising an operating state of the electronic device in which the electronic device is configured to receive wireless communication signals; initiating, at the electronic device and based on receiving wireless communication signals, one or more operations; and switching, at the electronic device, from the second mode to the first mode, the switching based on a completion of the one or more operations.

Example 2: The method of example 1, wherein the electronic device is sealed within a package, the package preventing direct, wired communication outside of the package, and wherein the package does not prevent a propagation of the magnetic field or of the wireless communication signals.

Example 3: The method of example 1 or 2, wherein the first mode is a shipping mode configured to operate the electronic device in a manner that is compliant with one or more international shipping standards and the second mode is further configured to facilitate a charging of the electronic device or additional electronic devices associated with the electronic device.

Example 4: The method of any of previous example, wherein the switching from the first mode to the second mode is responsive to determining that the magnetic field is an externally applied coded magnetic field having one or more magnetic field oscillations, the magnetic field oscillations comprising a particular characteristic for a predetermined duration, the particular characteristic including a particular frequency and/or particular magnitude.

Example 5: The method of any of the previous examples, wherein initiating the one or more operations includes booting up the electronic device and determining authenticity of the magnetic field.

Example 6: The method of any of the previous examples, further comprising, after or concurrent with booting up the electronic device, determining whether the magnetic field is authentic based on a characteristic of the one or more magnetic field oscillations matching a prescribed characteristic.

Example 7: The method of example 5, wherein switching from the second mode to the first mode based on the completion of the one or more operations comprises deactivating a wireless communication component of the electronic device and minimizing energy expenditure by one or more processors of the electronic device.

Example 8: The method of any of the previous examples, wherein the one or more operations comprise a software-based action installing a software update.

Example 9: The method of example 8, wherein: the electronic device houses one or more wireless hearable devices; the one or more operations further comprise: activating the one or more wireless hearable devices; and installing the software update on the one or more wireless hearable devices after activating the one or more wireless hearable devices; and/or the switching from the second mode to the first mode based on the completion of the one or more operations comprises a deactivation of the one or more wireless hearable devices.

Example 9.5: The method of any of the previous examples, wherein the oscillating magnetic field comprises a magnetic field, and wherein the one or more magnetic field oscillations comprise magnetic oscillations.

Example 10: The method of any previous example, wherein the electronic device includes one or more intrinsic magnetic field producing components, the method further comprising: determining that the detected magnetic field is an extrinsic magnetic field, the extrinsic magnetic field originating from a source external to the electronic device, and wherein the switching is further based on the determination that the detected magnetic field is an extrinsic magnetic field.

Example 11: The method of example 10, wherein the package comprises at least one of paper or plastic, and wherein the electronic device is sealed within the package at a factory.

Example 12: The method of any of the previous examples, further comprising, wirelessly charging the electronic device, and wherein, optionally, the oscillating magnetic field wirelessly charges the electronic device.

Example 13: The method of example 12, wherein the magnetic field wirelessly charges the electronic device.

Example 14: The method of any of the previous examples, wherein the first operating state of the electronic device comprises a deactivation of wireless communication components to disable wireless communication.

Example 15: The method of any of the previous examples, wherein the second operating state of the electronic device further configures the electronic device to transmit wireless communication signals.

Example 16: The method of example 15, further comprising: transmitting, from the electronic device and responsive to switching from the first mode to the second mode, wireless communication signals, the wireless communication signals indicative of a magnetic field detection.

Example 17: The method of example 15, further comprising: transmitting, from the electronic device and responsive to initiating one or more operations, wireless communication signals, the wireless communication signals indicative of initiation of one or more operations.

Example 18: The method of example 15, further comprising: transmitting, from the electronic device and prior to switching from the second mode to the first mode, wireless communication signals, the wireless communication signals indicative of an execution or completion of the one or more operations.

Example 19: A system comprising a wireless communication component, an electromagnetic wave detector, one or more processors, and memory coupled to the one or more processors, the memory storing one or more programs configured to be executed by the one or more processors, the one or more programs including instructions for: producing a magnetic field via the magnetic field producing component, the magnetic field having one or more magnetic field oscillations radiating at a particular frequency and/or a particular magnitude; responsive to, or concurrent with, receiving an indication of a mode of an electronic device using the electromagnetic wave detector, transmitting wireless communication signals to a wireless communication component of the electronic device, the wireless communication signals directing the electronic device to perform one or more operations; and responsive to determining a successful completion of the one or more operations from the electronic device, providing a notification.

Example 20: The system of example 19, wherein the system further comprises a solenoid, and wherein generating the magnetic field is generated by the solenoid, the magnetic field including one or more magnetic field oscillations having a particular characteristic.

Example 21: The system of example 20, wherein the particular characteristic comprises one or more magnetic field oscillations having a particular frequency.

Example 22: The system of example 20, wherein the particular characteristic comprises one or more magnetic field oscillations having a particular magnitude.

Example 23: The system of example 20, wherein the one or more magnetic field oscillations include the particular characteristic for a predetermined duration.

Example 24: The system of examples 19-23, wherein the system receives the indication of the mode of the electronic device via the wireless communication component, the indication of the mode received passively by the wireless communication component such that the wireless communication component intercepts wireless communications between two electronic components associated with the electronic device.

Example 25: The system of example 24, wherein the two electronic components comprise earbuds stored within the electronic device, the earbuds configured to transmit wireless communication signals between each other in response to a mode switching of the electronic device.

Example 26: The system of examples 19-25, further comprising: determining that a predetermined duration has elapsed before receiving the indication of the mode of the electronic device; and generating an additional magnetic field, the additional magnetic field having one or more magnetic field oscillations radiating at a particular frequency and a particular magnitude.

Example 27: The system of examples 19-26, further comprising: providing instructions prior to generating the additional magnetic field, the instructions indicative of a request to reposition a package including the electronic device.

Example 28: The system of example 27, wherein the system further comprises a display, and wherein the display is configured to present the instructions indicative of a request to reposition the package including the electronic device.

Example 29: The system of examples 19-28, further comprising: providing instructions to a user responsive to a determination that a package including the electronic device is identified as being improperly positioned.

Example 30: The system of example 29, wherein the identification that the package including the electronic device is improperly positioned is based on at least one of a proximity sensor, an image sensor, a scale, or a radar sensor.

Example 31: The system of examples 19-30, wherein the wireless communication signals transmitted to the electronic device comprise data for installation on the electronic device.

Example 32: The system of examples 19-31, wherein the notification comprises at least one of an audible notification or a visual notification.

Example 33: The system of examples 19-32, further comprising: charging the electronic device.

Example 34: The system of example 33, wherein the magnetic field is configured to charge the electronic device.

Example 35: The system of example 33, wherein the system further comprises a wireless charging unit, the wireless charging unit configured to wirelessly charge the electronic device.

Example 36: The system of examples 19-35, wherein the system is configured to generate a magnetic field including one or more magnetic field oscillations having a particular characteristic based on a type of electronic device.

Example 37: The system of examples 19-36, wherein the system further comprises an audio input/output mechanism, the system further comprising: generating an audible cue responsive to receiving the indication of the mode of the electronic device.

Example 38: The system of examples 19-37, wherein the system is manufactured in a single device, and wherein a package including the electronic device is configured to be positioned adjacent to an exterior face of the single device.

Example 39: An electronic device comprising: a housing having a front face and a rear face, the housing comprising: a body defining at least one internal cavity for receiving at least one portable electronic device, the body comprising: a magnetic field sensing device; and a lid configured to expose the at least one internal cavity in an open configuration, the lid comprising: a magnet configured to produce a magnetic field, the magnet positioned in the lid within a vicinity of the magnetic field sensing device when the lid is in a closed configuration, the magnet removed from the vicinity of the magnetic field sensing device when the lid is in the open configuration; a wireless communication component configured to transmit wireless communication signals; one or more processors, the one or more processors configured to implement at least one of a first mode or a second mode, the first mode comprising an operating state of the electronic device in which the electronic device expends less electrical power than in an operating state of the electronic device in the second mode, the second mode comprising an operating state of the electronic device in which the electronic device is configured to receive wireless communication signals; and memory coupled to the one or more processors, the memory storing one or more programs configured to be executed by the one or more processors, the one or more programs including instructions for: detecting, via the magnetic field sensing device, a magnetic field, the magnetic field originating from a source external to the electronic device; switching, based on the detection of the magnetic field, from the first mode to the second mode; initiating, at the electronic device and based on receiving wireless communication signals; and switching, at the electronic device, from the second mode to the first mode, the switching based on a completion of the one or more operations.

Example 40: The electronic device of example 39, wherein the magnetic field sensing device is a Hall Effect Sensor configured to detect a magnetic field, the magnetic field comprising one or more magnetic field oscillations.

Example 41: The electronic device of example 40, wherein the magnet is a permanent magnet, the magnet producing a magnetostatic field, and wherein the magnetic field sensing device is configured to detect the magnetostatic field.

Example 42: The electronic device of any of examples 39-41, wherein the at least one portable electronic device comprises one or more wireless hearable devices.

Example 43: The electronic device of any of examples 39-42, wherein the first mode comprises an operating state of the electronic device in which the wireless communication component is deactivated, the deactivation disabling at least one of wireless communication transmission or reception.

Example 44: The electronic device of any of examples 39-43, further comprising a battery configured to power the one or more processors and recharge the at least one portable electronic device.

Example 45: The electronic device of example 44, wherein the battery is a rechargeable battery, the rechargeable battery configured to recharge via at least one of wireless charging or wired charging.

Example 46: The electronic device of example 45, wherein the magnetic field having one or more magnetic field oscillations is configured to recharge the rechargeable battery.

Example 47: The electronic device of any of examples 39-46, wherein the housing of the electronic device comprises an ovoid shape, the lid comprising a top portion of the ovoid-shaped housing.

Example 48: The electronic device of any of examples 39-47, wherein the lid is configured to rotate about a hinge coupled to the body proximate the rear face of the housing, the lid configured to expose the at least one internal cavity from an axis normal to the front face when rotated about the hinge.

Example 49: The electronic device of any of examples 39-48, wherein the lid is configured to slide in a direction parallel to a plane defined by at least one of the front face or the rear face, the lid configured expose the at least one internal cavity when adjusted.

Example 50: The electronic device of any of examples 39-49, wherein the electronic device is sealed within a package, the package preventing direct, wired communication outside of the package, and wherein the package does not prevent wireless communication.

Example 51: The electronic device of any of examples 39-50, wherein the package comprises at least one of paper or plastic, and wherein the electronic device is sealed within the package at a factory.

### CONCLUSION

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations directed at external magnetic activation to initiate device processing have been described in language specific to certain features and/or methods, the subject of the appended Claims is not necessarily limited to the specific features or methods described. Rather, the specific features and methods are disclosed as example implementations directed at external magnetic activation to initiate device processing.

1. A method comprising:
detecting, at an electronic device, a magnetic field, the magnetic field originating from a source external to the electronic device;
switching, at the electronic device and based on the detection of the magnetic field, from a first mode to a second mode, the first mode comprising an operating state of the electronic device in which the electronic device expends less electrical power than an operating state of the electronic device in the second mode, the second mode comprising the operating state of the electronic device in which the electronic device is configured to receive wireless communication signals;
initiating, at the electronic device and based on receiving wireless communication signals, one or more operations; and
switching, at the electronic device, from the second mode to the first mode, the switching based on a completion of the one or more operations.

2. The method of claim 1, wherein the electronic device is sealed within a package, the package preventing direct, wired communication outside of the package, and wherein the package does not prevent a propagation of the magnetic field or of the wireless communication signals.

3. The method of claim 1, wherein the first mode is a shipping mode configured to operate the electronic device in a manner that is compliant with one or more international shipping standards and the second mode is further configured to facilitate a charging of the electronic device or additional electronic devices associated with the electronic device.

4. The method of claim 1, wherein the switching from the first mode to the second mode is responsive to determining that the magnetic field is an externally applied coded magnetic field having one or more magnetic field oscillations, the one or more magnetic field oscillations comprising a particular characteristic for a predetermined duration, the particular characteristic including a particular frequency and/or particular magnitude.

5. The method of claim 4, wherein initiating the one or more operations includes booting up the electronic device and determining authenticity of the magnetic field.

6. The method of claim 5, further comprising, after or concurrent with booting up the electronic device, determining whether the magnetic field is authentic based on a characteristic of the one or more magnetic field oscillations matching a prescribed characteristic.

7. The method of claim 1, wherein switching from the second mode to the first mode based on the completion of the one or more operations comprises deactivating a wireless communication component of the electronic device and minimizing energy expenditure by one or more processors of the electronic device.

8. The method of claim 1, wherein the one or more operations comprise a software-based action installing a software update.

9. The method of claim 8, wherein:
the electronic device houses one or more wireless hearable devices;
the one or more operations further comprise:
activating the one or more wireless hearable devices; and
installing the software update on the one or more wireless hearable devices; and
the switching from the second mode to the first mode based on the completion of the one or more operations comprises a deactivation of the one or more wireless hearable devices after activating the one or more wireless hearable devices.

10. The method of claim 1, wherein the electronic device includes one or more intrinsic magnetic field producing components, the method further comprising:
determining that the detected magnetic field is an extrinsic magnetic field, the extrinsic magnetic field originating from a source external to the electronic device, and wherein the switching is further based on the determination that the detected magnetic field is an extrinsic magnetic field.

11. The method of claim 1, wherein the second mode comprises the operating of the electronic device in which the electronic device is further configured to transmit wireless communication signals.

12. The method of claim 11, further comprising:
transmitting, from the electronic device and prior to switching from the second mode to the first mode, wireless communication signals indicative of the completion of the one or more operations.

13. The method of claim 1, wherein the magnetic field having one or more magnetic field oscillations charges a battery of the electronic device.

14. An electronic device comprising:
a wireless communication component;
a magnetic field sensing device;
one or more processors; and
memory coupled to the one or more processors, the memory storing one or more programs configured to be executed by the one or more processors, the one or more programs configured to:
detect a magnetic field, with the magnetic field sensing device, from a source external to the electronic device;
switch, based on the detection of the magnetic field, the electronic device from a first mode to a second mode, the first mode comprising an operating state of the electronic device in which the electronic device expends less electrical power than an operating state of the electronic device in the second mode, the second mode comprising the operating state of the electronic device in which the electronic device is configured to receive wireless communication signals;
initiate, based on receiving wireless communication signals, one or more operations; and
switch the electronic device from the second mode to the first mode based on a completion of the one or more operations.

15. The electronic device of claim 14, wherein the electronic device is a portable electronic case, the portable electronic case configured to store one or more wireless hearable devices.

16. A system comprising:
a wireless communication component;
a magnetic-field-producing component;
an electromagnetic wave detector;
one or more processors; and
memory coupled to the one or more processors, the memory storing one or more programs configured to be executed by the one or more processors, the one or more programs including instructions for:
producing a magnetic field via the magnetic-field-producing component, the magnetic field having one or more magnetic field oscillations radiating at a particular frequency or a particular magnitude;
responsive to, or concurrent with, receiving an indication of a mode of an electronic device using the electromagnetic wave detector, transmitting wireless communication signals to a wireless communication component of the electronic device, the wireless communication signals direction the electronic device to perform one or more operations; and
responsive to determining a successful completion of the one or more operations from the electronic device, providing a notification.

17. The system of claim 16, further comprising:
a solenoid, wherein the solenoid generates the magnetic field, the magnetic field having a particular characteristic.

18. The system of claim 17, wherein:
the particular characteristic comprises one or more magnetic field oscillations having a particular frequency;
the particular characteristic comprises one or more magnetic field oscillations having a particular magnitude; or
the one or more magnetic field oscillations include the particular characteristic for a predetermined duration.

19. The system of claim 16, wherein the system receives the indication of the mode of the electronic device via the wireless communication component, the indication of the mode received passively by the wireless communication component such that the wireless communication component intercepts wireless communications between two electronic components associated with the electronic device.

20. The system of claim 19, wherein the two electronic components comprise earbuds stored within the electronic device, the earbuds configured to transmit wireless communication signals between each other in response to a mode switching of the electronic device.
